(19) United States
(12) Patent Application Publication
(10) Pub. No.: US 2010/0034629 A1
(43) Pub. Date: Feb. 11, 2010

(54) LOAD HANDLING APPARATUS FOR CARGO VEHICLE

(76) Inventor: David Hamann, Luverne, MN (US)

Correspondence Address: JAY M. SCHLOFF, 6960 Orchard Lake Road, Suite 315, West Bloomfield, MI, 48322, US

(21) Appl. No.: 12/534,888

(22) Filed: Aug. 4, 2009

Related U.S. Application Data
(60) Provisional application No. 61/087,347, filed on Aug. 8, 2008.

(51) Int. Cl. B60P 1/00

(52) U.S. Cl. 414/462

(57) ABSTRACT

A load handling apparatus to be mounted on a cargo area of a cargo vehicle is provided. The load handling apparatus comprises a pair of guide rail members adapted to be mounted on the cargo area, a support assembly having a first support member and a second support member slidably coupled to the pair of guide rail member for facilitating a slidable movement of the support assembly on the pair of guide rail members, a roller assembly adapted to slidably couple the support assembly to the pair of guide rail members, and at least one latching assembly adapted to selectively lock and unlock the slidable movement of the support assembly on the pair of guide rail members. The support assembly further comprises at least one bar member extending between the first support member and the second support. The support assembly is adapted to support a load thereon.

### CROSS REFERENCE TO RELATED APPLICATIONS

The present disclosure claims priority under 35 United States Code, Section 119 on the U.S. Provisional Patent Application No. 61/087,347 filed on Aug. 8, 2008, the disclosure of which is incorporated by reference.

### FIELD OF THE DISCLOSURE

The present disclosure generally relates to cargo vehicles, and, more particularly to a load handling apparatus for a cargo vehicle that facilitates supporting and moving a load on a cargo area of the cargo vehicle.

### BACKGROUND OF THE DISCLOSURE

Cargo vehicles, for example, pickup trucks and vans, are utilized for carrying and transporting loads, such as goods, luggage, and storage containers from one place to another. Generally, the load is kept on a cargo area, such as a bed or a floor of the cargo vehicle.

The load kept on the cargo area of the cargo vehicle may be handled by an individual by pulling or pushing the load manually. For example, while moving the load between a front portion and a rear portion of the bed of the cargo vehicle, the individual may be required to push or pull the load manually over the bed of the cargo vehicle. The amount of manual push or pull required to move the load may depend on the weight of the load. For example, in a case of heavy loads manual movement of the load becomes difficult and requires substantial physical labor. Moreover, for moving the load or accessing the load, the individual may have to climb onto the bed of the cargo vehicle, which may be cumbersome and time consuming for the individual.

Accordingly, there exists a need of a load handling apparatus for a cargo vehicle that enables an individual in handling load on a cargo area of the cargo vehicle by applying a minimum of physical labor. Further, there also exists a need of a load handling apparatus for a cargo vehicle that facilitates handling of load in a time efficient manner.

### SUMMARY OF THE DISCLOSURE

In view of the forgoing disadvantages inherent in the prior-art, the general purpose of the present disclosure is to provide a load handling apparatus for a cargo vehicle, to include all advantages of the prior art, and to overcome the drawbacks inherent in the prior art.

Accordingly, an object of the present disclosure is to provide a load handling apparatus for a cargo vehicle, which is capable of handling a heavy load on a cargo area, thereby minimizing physical labor required for handling the load.

Another object of the present disclosure is to provide a load handling apparatus for a cargo vehicle, which facilitates handling of load in a time efficient manner.

To achieve the above objects, in an aspect of the present disclosure, a load handling apparatus for a cargo vehicle is provided. The load handling apparatus comprises a pair of guide rail members, a support assembly, a roller assembly, and at least one latching assembly. The pair of guide rail members is adapted to be mounted on a cargo area of the cargo vehicle in a parallely spaced apart relationship. Each guide rail member of the pair of guide rail members includes a channel configured along a length thereof. The support assembly is adapted to support a load thereon. The support assembly comprises a first support member and a second support member parallely spaced apart from each other. Each of the first support member and the second support member is slidably coupled to the channel of the each guide rail member for facilitating a slidable movement of the support assembly on the pair of guide rail members. The first support member is disposed in proximity to a rear edge of the cargo area of the cargo vehicle.

The support assembly further comprises at least one bar member extending between the first support member and the second support member for maintaining a fixed distance between the first support member and the second support member. Further, the roller assembly is adapted to slidably couple the first support member and the second support member to the channel of the each guide rail member. The at least one latching assembly is configured on the first support member. The at least one latching assembly is adapted to selectively lock and unlock the slidable movement of the first support member for locking and unlocking the slidable movement of support assembly on the pair of guide rail members.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, and in which:

FIG. 1 illustrates an exploded perspective view of a load handling apparatus, in accordance with an embodiment of the present disclosure;

FIG. 2 illustrates an environment in which the load handling apparatus of FIG. 1 is mounted on a cargo area of a cargo vehicle, in accordance with an embodiment of the present disclosure;

FIG. 3 illustrates a cross sectional view of a latching assembly of the load handling apparatus of FIG. 1, in accordance with an embodiment of the present disclosure; and

FIG. 4 illustrates an exploded perspective view of a load handling apparatus, in accordance with another embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a load handling apparatus for a cargo vehicle, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a load handling apparatus for a cargo vehicle. The load handling apparatus enables an individual in easy handling of a load on a cargo area of the cargo vehicle. Specifically, the load handling apparatus enables the individual in moving the load on the cargo area of the cargo vehicle with a minimum of physical effort. Further, the load handling apparatus facilitates movement of the load on the cargo area of the vehicle in a time efficient manner. Furthermore, the load handling apparatus facilitates supporting the load on the cargo area of the cargo vehicle. The term load used herein may be referred to as a storage container, such as a tool box, or a cargo such as an oil drum.

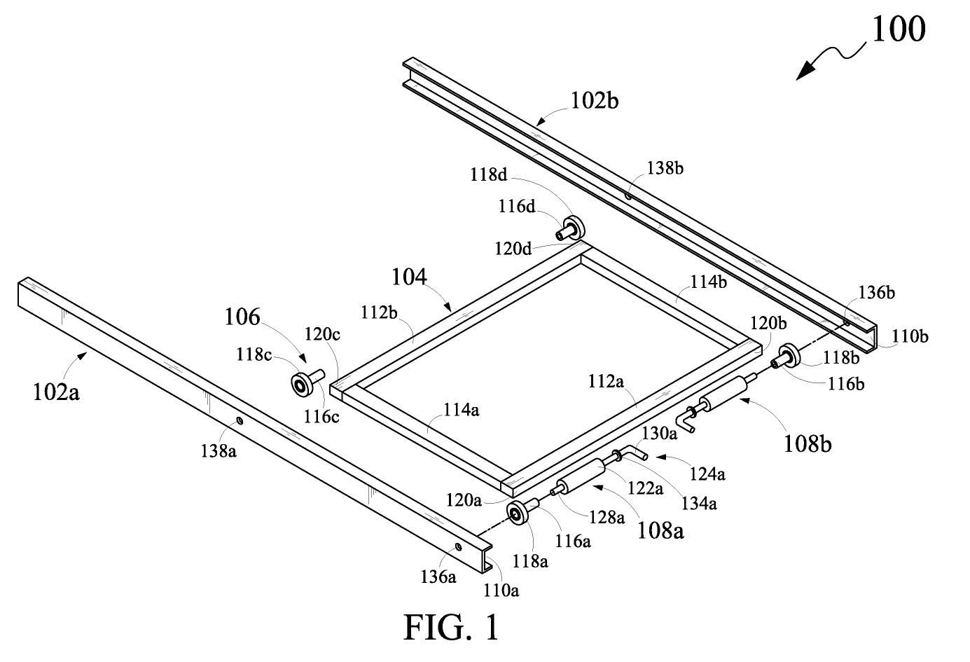

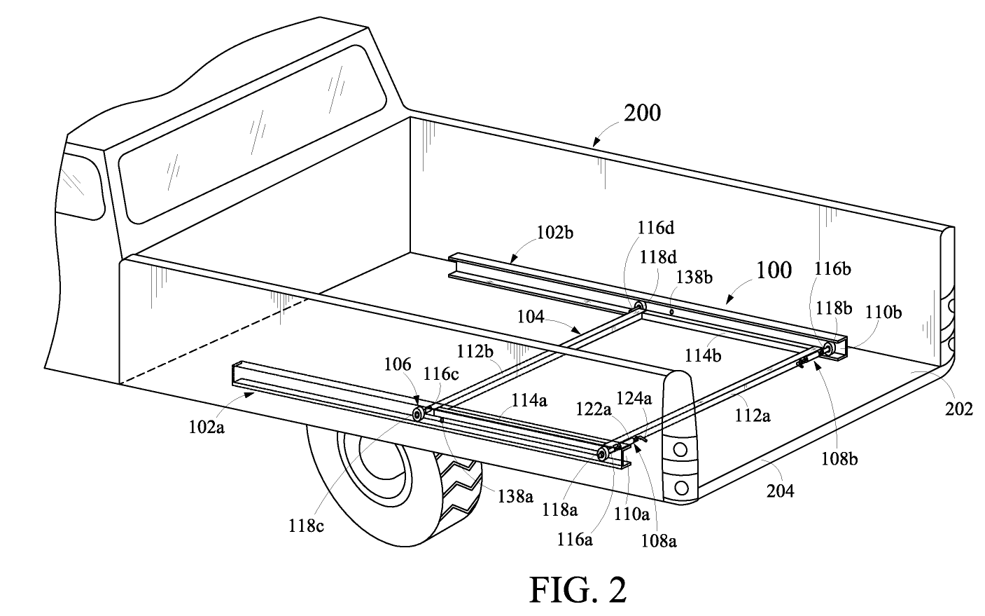

Referring to FIGS. 1 and 2, a perspective view of a load handling apparatus 100 (hereinafter referred to as an apparatus 100) is illustrated. More specifically, FIG. 1 illustrates an exploded perspective view of the apparatus 100, in accordance with an embodiment of the present disclosure, and FIG. 2 illustrates an environment in which the apparatus 100 of FIG. 1 is mounted in a cargo area 202 of a cargo vehicle 200, in accordance with an embodiment of the present disclosure.

As shown in FIG. 1, the apparatus 100 includes a pair of guide rail members 102a and 102b, a support assembly 104, a roller assembly 106, and at least one latching assembly, such as a latching assembly 108a and a latching assembly 108b (herein after collectively referred to as latching assemblies 108a, 108b). The pair of guide rail members 102a and 102b is adapted to be mounted on the cargo area 202, i.e. floor or bed, of the cargo vehicle 200, (as shown in FIG. 2), for mounting of the apparatus 100 on the cargo vehicle 200.

The pair of guide rail members 102a and 102b may be mounted on the cargo area 202 in a parallely spaced apart relationship. In one embodiment of the present disclosure, the pair of guide rail members 102a and 102b is removably coupled to the cargo area 202 using a suitable fastening mechanism, such as nut and bolt arrangement (not shown). The removable coupling of the pair of guide rail members 102a and 102b facilities reusing the apparatus 100 with different cargo vehicles. Moreover, it may be evident to those skilled in the art that the pair of guide rail members 102a and 102b may be rigidly coupled to the cargo area 202 of the cargo vehicle 200 by means of fastening mechanism, such as welding. Each of the pair of guide rail members 102a and 102b includes a channel, such as channels 110a and 110b, respectively configured along a length thereof. In the present embodiment, each of the pair of guide rail members 102a and 102b include a C-shaped channel, such as the channel 110a and 110b respectively.

The support assembly 104 is slidably coupled to the pair of guide rail members 102a and 102b for facilitating a slidable movement of the support assembly 104 on the pair of guide rail members 102a and 102b. The support assembly 104 includes a first support member 112a and a second support member 112b (hereinafter collectively referred to as support members 112a, 112b) parallely spaced apart from each other and positioned transverse to the pair of guide rail members 102a and 102b. The support assembly further includes at least one bar member, such as a bar member 114a and a bar member 114b (hereinafter collectively referred to as bar members 114a, 114b), extending between the first support member 112a and the second support member 112b. The at least one bar member, such as the bar members 114a, 114b, is capable of maintaining a fixed distance between the first support member 112a and the second support member 112b. The support assembly 104 is adapted to support a load thereon. In an embodiment of the present disclosure, the load includes a storage container (not shown) that may be utilized for storing articles, tools, and the like in the cargo area of the cargo vehicle.

The support members 112a, 112b of the support assembly 104 are slidably coupled to the channels 110a and 110b of the pair of guide rail members 102a and 102b. More specifically, the roller assembly 106 is adapted to slidably couple the support members 112a, 112b to the channels 110a and 110b, respectively, and thereby facilitating the slidable movement of the support assembly 104 on the pair of guide rail members 102a and 102b. The roller assembly 106 includes a plurality of hollow connecting members, such as hollow connecting members 116a, 116b, 116c and 116d, rigidly coupled to the support members 112a, 112b, and a plurality of roller bearings, such as roller bearings 118a, 118b, 118c and 118d rotatably coupled to the plurality hollow connecting members 116a, 116b, 116c and 116d, respectively.

Specifically, an end portion of each of the plurality of hollow connecting members 116a, 116b, 116c and 116d is rigidly coupled to a respective end portion of each of the support members 112a, 112b. For example, end portions (not numbered) of the hollow connecting members 116a and 116b is adapted to be rigidly coupled to end portions 120a and 120b, respectively, of the first support member 112a. Similarly, end portions (not numbered) of the hollow connecting members 116c and 116d are adapted to be rigidly coupled to end portions 120c and 120d, respectively, of the second support member 112b. In the present embodiment, the plurality of hollow connecting members 116a, 116b, 116c and 116d are bushings which may be rigidly coupled to the end portions 120a, 120b, 120c and 120d, respectively, by means of welding. However, it will be evident to a person skilled in the art that the plurality of hollow connecting members may be rigidly coupled to the end portions of the support members 112a, 112b by means of other fastening mechanisms know in art, such as adhesive fastening and the like.

Further, as explained herein the plurality of roller bearings 118a, 118b, 118c and 118d of the roller assembly 106 is rotatably coupled to the plurality hollow connecting members 116a, 116b, 116c and 116d, respectively. More specifically, an end portion (not shown) of the hollow connecting member 116a is received by the roller bearing 118a and rotatably coupled thereto. Similarly, end portions (not shown) of the hollow connecting members 116b, 116c, and 116d are received by the roller bearings 118b, 118c, and 118d, respectively, and rotatably coupled thereto.

Further, the plurality of roller bearings 118a, 118b, 118c and 118d is capable of being received in the channels 110a and 110b for traveling on the pair of guide rail members 102a and 102b. For example, the roller bearings 118a and 118c configured on the end portions 120a and 120c, respectively, of the support members 112a, 112b, respectively, are capable of being received in the channel 110a of the guide rail member 102a. Similarly, the roller bearings 118b and 118d configured on the end portions 120b and 120d, respectively, of the support members 112a, 112b, respectively, are capable of being received in the channel 110b of the guide rail member 102b. As illustrated in FIG. 2, upon the plurality of roller bearings 118a, 118b, 118c and 118d being received in the channels 110a and 110b, the first support member 112a is disposed in proximity to a rear edge 204 of the cargo area 202 of the cargo vehicle 200 and the second support member 112b is positioned away from the rear edge 204 of the cargo area 202.

The plurality of roller bearings 118a, 118b, 118c and 118d being received in the channels 110a and 110b enables the support assembly 104 to slidably move on the pair of guide rail members 102a and 102b. Further, the slidable movement of the support assembly 104 on the pair of guide rail members 102a and 102b is locked and unlocked by means of the at least one latching assembly, such as the latching assemblies 108a, 108b. As explained herein, in the present embodiment, the at least one latching assembly includes the latching assembly 108a and the latching assembly 108b. However, it will evident to a person skilled in the art that the at least one latching assembly may include more or fewer number of latching assemblies than as disclosed herein, depending upon the manufacturing requirement of the apparatus 100.

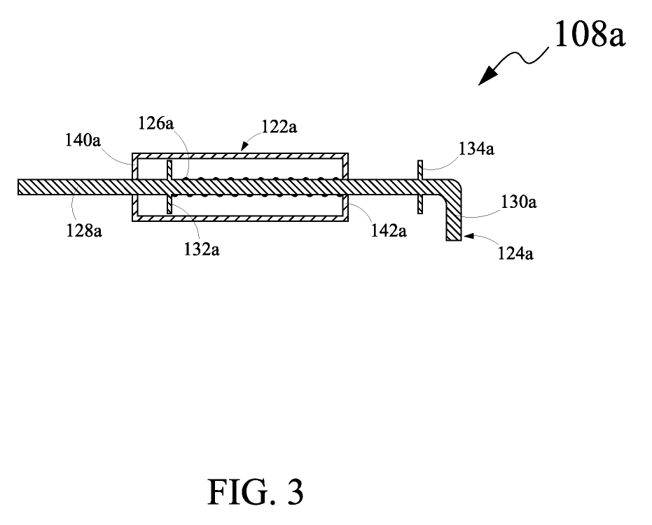

The latching assemblies 108a, 108b are configured on the first support member 112a of the support assembly 104. The latching assemblies 108a, 108b are adapted to selectively lock and unlock the slidable movement of the first support member 112a, thereby locking and unlocking the slidable movement of the support assembly 104 on the pair of guide rail members 102a and 102b. For example, the support assembly 104 may be locked in a front position, in proximity to the rear edge 204 of the cargo area 202. Alternatively, the support assembly 104 may be locked in a rear position away from the rear edge 204 of the cargo area 202 of the pair of guide rail members 102a and 102b. The latching assemblies 108a, 108b are further explained in detail in conjunction with FIG. 3.

Referring to FIG. 3, a cross sectional view of a latching assembly such as the latching assembly 108a of FIG. 1 is illustrated, in accordance with an embodiment of the present disclosure. The latching assembly 108a includes a tube member 122a, a pin member 124a, and a spring member 126a. The tube member 122a is disposed on a respective end portion of the first support member 112a. For example, the tube member 122a is disposed on the end portion 120a (as shown in FIG. 1), and adjacent to the hollow connecting member 116a. The pin member 124a is adapted to be received in the tube member 122a.

In the present embodiment, the pin member 124a is configured to assume an L-shaped structure. More specifically, the pin member 124a includes a longitudinal portion 128a adapted to be received in the tube member 122a and a lateral portion 130a substantially perpendicular to the longitudinal portion 128a and disposed outside the tube member 122a. The pin member 124a further includes a first flange 132a and a second flange 134a configured on the longitudinal portion 128a of the pin member 124a. The first flange 132a is enclosed in the tube member 122a and the second flange 134a is disposed outside the tube member 122a. The spring member 126a is enclosed within the tube member 122a in a manner such that the spring member 126a encircles a portion of the pin member 124a which is enclosed within the tube member 122a. More specifically, the spring member 126a encircles the portion of the pin member 124a between the first flange 132a and the tube member 122a.

In one embodiment of the present disclosure, the latching assembly 108a is a spring loaded pin. Further, it will be evident to a person skilled in the art that the structural configuration and the functionally of the latching assembly 108a is similar to the latching assembly 108b, accordingly the detail description of the latching assembly 108b is avoided for the sake of brevity.

Moreover, as explained herein, the latching assemblies 108a, 108b are capable of locking and unlocking the slidable movement of the support assembly 104 on the pair of guide rail members 102a and 102b. More specifically, in the present embodiment, the pair of guide rail members 102a and 102b includes a plurality of apertures configured along a length thereof. The plurality of apertures facilitates the latching assemblies 108a, 108b to lock and unlock the slidable movement of the support assembly 104 on the pair of guide rail members 102a and 102b. For example, the guide rail member 102a includes apertures 136a and 138a configured along the length thereof, and the guide rail member 102b includes apertures 136b and 138b configured along the length thereof, as shown in FIG. 1. Accordingly, when the pin member 124a of the latching assembly 108a is received through the hollow connecting member 116a, and thereafter passes through the aperture 136a, the first support member 112a attains a locked state on the guide rail member 102a.

It will be evident to a person skilled in the art that, a pin member (not numbered) of the latching assembly 108b may be similarly received through the hollow connecting member 116b and thereafter through the aperture 136b, for allowing the first support member 112a to attain the locked state on the guide rail member 102b. Accordingly, the first support member 112a attains the locked state on the pair of guide rail members 102a and 102b, thereby allowing the support assembly 104 to attain the locked state at the front position of the pair of guide rail members 102a and 102b. Similarly, when pin members of the latching assemblies 108a, 108b are received through the apertures 138a and 138b, the first support member 112a attains the locked state at the rear position of the pair of guide rail members 102a and 102b, thereby locking the support assembly 104 at the rear position of the pair of guide rail members 102a and 102b.

Further, in the locked state of the first support member 112a, the pin members of the latching assemblies 108a, 108b are retained in a received state within the hollow connecting members and apertures with the help of spring members of the latching assemblies 108a, 108b. More specifically, the spring member 126a of the latching assembly 108a is disposed between the first flange 132a and the tube member 122a in a compressed state thereof. Accordingly, the spring member 126a tends to push the first flange 132a towards a side wall 140a of the tube member 122a for allowing the longitudinal portion 128a of the pin member 124a to move outside the tube member 122a. Therefore, the longitudinal portion 128a of the pin member 124a is retained in the received state within the hollow connecting member 116a and the aperture 136a in the locked state of the first support member 112a at the front position. Similarly, a pin member (not numbered) of the latching assembly 108b may be retained in received state within the hollow connecting member 116b and the aperture 136b in the locked state of the first support member 112a at the front position, with the help of a spring member (not shown) latching assembly 108b.

Furthermore, the latching assemblies 108a, 108b allow the first support member 112a to attain an unlocked state for enabling the support assembly 104 to slidably move along the pair of guide rail members 102a and 102b. More specifically, when the lateral portion 130a of the pin member 124a is moved outwardly in a manner such that the spring member 126a gets compressed between the first flange 132a and a side wall 142a of the tube member 122a. Accordingly, the longitudinal portion 128a received in the hollow connecting member 116a and the aperture 136a moves out therefrom for allowing the first support member 112a to attain the unlocked state in the front position of the pair of guide rail members 102a and 102b. Similarly, the latching assembly 108b may be operated for allowing the first support member 112a to attain the unlocked state.

Therefore, in the unlocked state of the first support member 112a, when the support assembly 104 is supporting a load thereon, the load may be allowed to slidably move along the pair of guide rail members 102a and 102b with minimum physical effort. Specifically, the plurality of roller bearings 118a, 118b, 118c, and 118d coupled to the support members 112a, 112b of the support assembly 104, allows the load supported on the support assembly 104 to slidably move along the pair of guide rail members 102a and 102b.

Accordingly, the apparatus 100 of the present disclosure enables an individual in handling the load on the cargo area of the cargo vehicles. For example, the apparatus 100 may enable the individual in moving the load on the cargo area of the cargo vehicle, such as moving the load from a front position of the cargo area to a rear position of the cargo area, with minimum physical effort. Furthermore, due to such movement of the load on the cargo area of the cargo vehicle, the loading and unloading becomes easy.

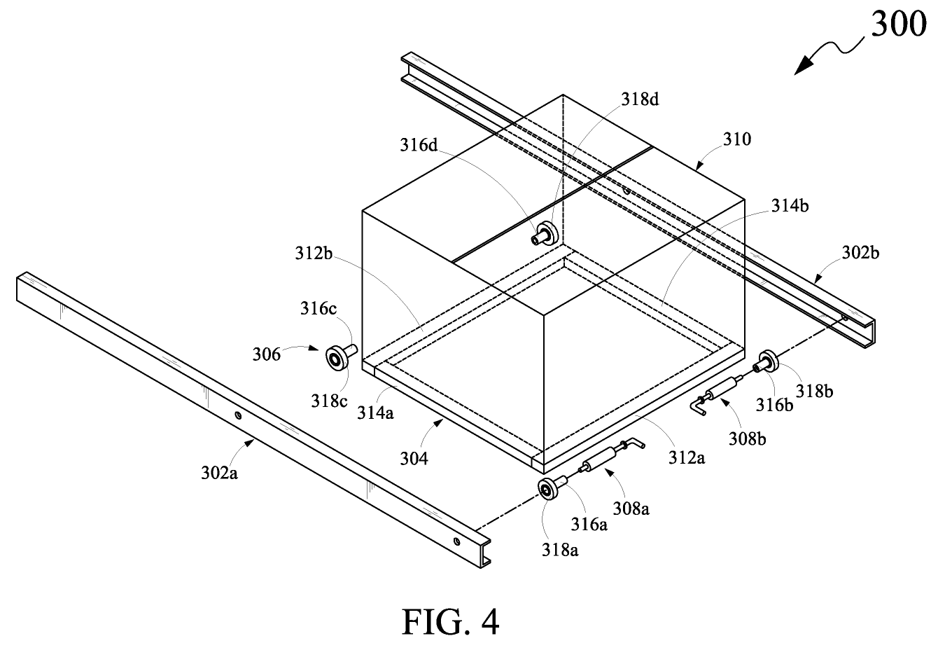

Referring to FIG. 4, an exploded perspective view of a load handling apparatus 300 (hereinafter referred to as apparatus 300) is illustrated, in accordance with another embodiment of the present disclosure. The apparatus 300 includes a pair of guide rail members 302a and 302b, a support assembly 304 slidably coupled to the pair of guide rail members 302a and 302b, a roller assembly 306 adapted to slidably couple the support assembly 304 to the pair of guide rail members 302a and 302b, at least one latching assembly, such as latching assemblies 308a and 308b, adapted to selectively lock and unlock the support assembly 304 on the pair of guide rail members 302a and 302b, and a storage container 310 mounted on the support assembly 304.

The pair of guide rail members 302a and 302b, the support assembly 304, the roller assembly 306, and the latching assemblies 308a, 308b, are similar to the pair of guide rail members 102a and 102b, the support assembly 104, the roller assembly 106, and the latching assemblies 108a, 108b, accordingly description thereof is omitted for the sake of brevity.

In the present embodiment, the support assembly 304 includes a first support member 312a, 312b parallely spaced apart from each other, and at least one bar members, such as bar members 314a and 314b extending between the support members 312a, 312b. The support assembly 304, particularly, the support members 312a, 312b and bar members 314a and 314b support the storage container 310 thereon. Further, the roller assembly 306 includes a plurality of hollow connecting members, such as hollow connecting members 316a, 316b, 316c and 316d, and a plurality of roller bearings, such as rollers bearings 318a, 318b, 318c and 318d.

The support members 312a, 312b, the bar members 314a, 314b, the hollow connecting members 316a, 316b, 316c and 316d, and the plurality of roller bearings 318a, 318b, 318c and 318d, are similar to the support members 112a, 112b, the bar members 114a, 114b, the hollow connecting members 116a, 116b, 116c and 116d, and the plurality of roller bearings 118a, 118b, 118c and 118d, accordingly description thereof is omitted for the sake of brevity.

As shown in FIG. 4, the storage container 310 is supported on the support members 312a, 312b and the bar members 314a, 314b. Further, the support members 312a, 312b are slidably coupled to the pair of guide rail members 302a and 302b, accordingly the storage container 310 is capable of slidably moving along the pair of guide rail members 302a and 302b with minimum physical effort. Specifically, the plurality of roller bearings 318a, 318b, 318c, and 318d coupled to ends portions (not numbered) of the first support member 312a and the second support member 312b, and received in channels (not numbered) of the pair of guide rail members 302a and 302b, allows the storage container 310 to slidably move along the pair of guide rail members 302a and 302b.

In the present embodiment, the load includes the storage container 310; however it will be evident to those skilled in the art that the load may be an oil drum and the like. For example, the storage container 310 may be a tool box for storing tools therein. Accordingly, the apparatus 300 of the present embodiment enables individual in handling the tool box, with tools stored therein, in the cargo area of the cargo vehicles. For example, the tools may be moved from a front position of the cargo area to a rear position of the cargo area with minimum physical effort. Furthermore, the storage container may be selectively locked and unlocked at a desired position on the pair of guide rail members 302a and 302b, using the latching assemblies 308a and 308b. Accordingly, the apparatus 300 of the present embodiment enables an individual in easy handling of the tools, stored within the storage container 310, on the cargo area of the cargo vehicles.

The load handling apparatus, such as the load handling apparatus 100 and 300, provides an efficient and cost effective solution for handling of a load on a cargo area of a cargo vehicle. More specifically, the load handling apparatus enables individuals in moving, supporting, and storing of the load on the cargo area of the cargo vehicle. The load handling apparatus of the present disclosure may be configured to have various sizes for enabling the use thereof in conjunction with various sizes cargo vehicles. The load handling apparatus of the present disclosure may be manufactured of metals, such as aluminium and stainless-steel. In a preferred embodiment, the load handling apparatus may have the following dimensions: a length of 48 inches and a width of 18 inches. Further, elements of the load handling apparatus, such as a pair of guide rail members, may have a width of 2 inches, and a plurality of roller bearings may be diameter of 1½ inches.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A load handling apparatus for a cargo vehicle, the load handling apparatus comprising:
a pair of guide rail members adapted to be mounted on a cargo area of the cargo vehicle in a parallely spaced apart relationship, each guide rail member of the pair of guide rail members having a channel configured along a length thereof;
a support assembly adapted to support a load thereon, the support assembly comprising
a first support member and a second support member parallely spaced apart from each other, each of the first support member and the second support member slidably coupled to the channel of the each guide rail member for facilitating a slidable movement of the support assembly on the pair of guide rail members, the first support member being disposed in proximity to a rear edge of the cargo area of the cargo vehicle, and
at least one bar member extending between the first support member and the second support member for maintaining a fixed distance between the first support member and the second support member;
a roller assembly adapted to slidably couple the first support member and the second support member to the channel of the each guide rail member; and
at least one latching assembly configured on the first support member, the at least one latching assembly adapted to selectively lock and unlock the slidable movement of the first support member for locking and unlocking the slidable movement of support assembly on the pair of guide rail members.

2. The load handling apparatus of claim 1, wherein the roller assembly comprises
a plurality of hollow connecting members, each of the plurality of hollow connecting members rigidly coupled to a respective end portion of each of the first support member and the second support member, and
a plurality of roller bearings, each of the plurality of roller bearings rotatably coupled to a respective hollow connecting member of the plurality of hollow connecting members.

3. The load handling apparatus of claim 2, wherein the at least one latching assembly comprises
a tube member disposed on a respective end portion of the first support member,
a pin member adapted to be received in the tube member, the pin member having a first flange enclosed in the tube member and a second flange disposed outside the tube member, and
a spring member enclosed within the tube member, the spring member encircling a portion of the pin member enclosed within the tube member.

4. The load handling apparatus of claim 3, wherein each of the pair of guide rail members comprises a plurality of apertures configured thereon, the plurality of apertures facilitates in locking and unlocking the slidable movement of support assembly on the pair of guide rail members.

5. The load handling apparatus of claim 4, wherein the pin member is capable of being received through a hollow connecting member of the plurality of hollow connecting members, and an aperture of the plurality of apertures for locking the slidable movement of the support assembly on the pair of guide rail members.

6. The load handling apparatus of claim 1, wherein the load comprises a storage container, the storage container capable of being mounted on the support assembly.
